(19) United States
(12) Patent Application Publication
(10) Pub. No.: US 2025/0048129 A1
(43) Pub. Date: Feb. 6, 2025

(54) METHOD AND APPARATUS FOR BEAM MANAGEMENT

(71) Applicant: Huawei Technologies Co., Ltd., Shenzhen (CN)

(72) Inventors: Mostafa Medra, Kanata (CA); Mohammadhadi Baligh, Ottawa (CA)

(21) Appl. No.: 18/922,029

(22) Filed: Oct. 21, 2024

Related U.S. Application Data
(63) Continuation of application No. PCT/CN2022/089245, filed on Apr. 26, 2022.

(51) Int. Cl. H04W 16/28; H04B 7/06; H04B 17/318; H04W 64/00

(52) U.S. Cl. CPC H04W 16/28; H04B 7/06952; H04B 17/328; H04W 64/006

(57) ABSTRACT

A new method of classifying beams according to their reliability is provided; various procedures for quantifying beam reliability are provided. Methods of base station-UE communication to classify such beams are provided. New beam management procedures that are based on the new beam classification are provided.

### CROSS REFERENCE

The application is a continuation of International Application No. PCT/CN2022/089245, filed on Apr. 26, 2022, the disclosure of which is hereby incorporated by reference in its entirety.

### TECHNICAL FIELD

The application relates to wireless communications generally, and more specifically to beam management in wireless communications systems.

### BACKGROUND

Communication systems that are either implemented or proposed for 5G or beyond are typically focused on beam-based communication. Whether the system implements analog or digital beamforming or a combination thereof, the beamforming component is always crucial to deliver higher gains to the user equipments (UEs). The purpose of these extra gains is to counteract the extra losses when using higher frequencies for communication. Accordingly, the base station typically uses a set of beams and communicates to each UE using one or more beams. Using these beams, that point to certain areas, involves the use of various beam management procedures. For example, a base station may periodically initiate beam sweeping, where a several beams are sequentially activated covering the whole area that is served by this base station. The UE may measure the received power from each beam to determine the best beam for communication. This may be part of a beam sweeping procedure or initial access procedure. The base station may refine a certain beam for one UE or more in a beam refinement procedure to provide higher gains. A beam tracking procedure refers to the continuous tracking of the communication beam and switching to another beam if required and may involve initiating a beam switching procedure. The communication beam may become blocked by an obstacle which may result in the initiation of beam failure detection and recovery.

It can be seen that there are various procedures that are periodically executed in order to make sure that the beam(s) serving the UE always has a certain receive power which is high enough for proper detection and decoding of the data. These procedures typically classify the beams according to their reference signal received power (RSRP). For example, a base station may initiate beam switching for a certain UE if another beam has a higher RSRP than the serving beam RSRP, and the RSRP difference to trigger the beam switching may be defined as an offset at the base station. The RSRP metric is dominant in beam management procedures as it relates directly to the quality of the signal received by such beam.

A beam switching procedure may happen at the base station in a few steps. First, the UE provides regular reference signal received power (RSRP) measurements for a serving communication beam, and may be instructed to provide RSRP for other beams that have high RSRP as well. The base station may use a certain filter for each beam's RSRP values to provide an average filtered value that is less affected by noise and small-scale fluctuations. Then, the base station uses an offset value to compare the filtered RSRP of the serving beam to other reported beam, and when one beam provides a filtered value that is higher than that of the serving beam by a certain defined offset, the base station may send a beam switching command to the UE. The UE may confirm the beam switching, and then starts communication on the new beam after a certain defined delay. The procedure happens while both base station and UE are still communicating and largely starts at the base station side.

A beam failure detection happens at the UE when the beam RSRP value drops below a defined level at which communication may be unreliable. At such a level, the UE may be unable to properly decode and detect the received signaling and data. The UE checks the received beam using a preconfigured procedure to make sure that the beam actually failed. That includes measuring the beam RSRP for one or more times, as configured, and also considering certain time constraints that are to be met to conclude a failure has occurred. Once the procedure is completely executed, the UE starts beam failure recovery to try to connect to the base station again. The UE may have a list that is updated by the base station that includes one or more beams for this procedure. The UE checks these beams' RSRP in a preconfigured procedure to find if one beam is acceptable for re-establishing the communication. This may include a requirement that one or more RSRP measurements meet certain configured time constraints. These procedures happen at the UE side while the UE is temporarily disconnected. The beam failure recovery is considered a success if the UE manages to establish communication to the base station again, otherwise, the UE may announce beam failure and start trying to connect as in initial access.

### SUMMARY

According to one aspect of the present disclosure, there is provided a method in a network device, the method comprising: communicating between the network device and an apparatus information related to one or more beam reliabilities, wherein each beam reliability relates to beam time-of-stay or beam blockage probability and beam time-of-stay for a respective beam for the apparatus. The current beam management procedures rely solely on beam RSRP to take decisions. This results in using beams regardless of their suitability to UE location, speed, orientation, etc. This approach may also lead to longer delays in beam failure detection and recovery that could have been avoided. A new beam reliability measure is provided that can provide better insights regarding which beam to use for a specific UE.

In some embodiments, the information related to one or more beam reliabilities comprises a respective set of one or more bits indicating reliability of each beam.

In some embodiments, the one or more bits are used to classify each beam into one of up to 2 levels of reliability, where N is the number of bits in the respective set of bits indicating reliability of each beam.

In some embodiments, each level of beam reliability is associated with a respective range of beam time-of-stay and beam blockage probability.

In some embodiments, the information related to one or more beam reliabilities is obtained from one or more of an estimate of location of the apparatus; an estimate of velocity of the apparatus; an information store containing information about which beams can be used as a function of location; an information store containing information about blockage probability as a function of location and time; sensing information obtained by either the network device or the apparatus.

In some embodiments, the method further comprises: transmitting signaling to an apparatus requesting the apparatus to transmit feedback regarding a certain beam or beams for the purpose of building beam reliability information; receiving the requested feedback.

In some embodiments, the method further comprises: transmitting signaling to an apparatus configuring a number of bits to be used to convey beam reliability.

In some embodiments said communicating comprises receiving from the apparatus the information related to one or more beam reliabilities that was produced using sensing information obtained at the apparatus.

In some embodiments, the method further comprises: based on the one or more beam reliabilities, transmitting signaling to the apparatus, the signaling configuring beam RSRP reporting.

In some embodiments, the method further comprises: receiving beam RSRP measurements from the apparatus; performing beam switching taking into account the one or more reliabilities and the received RSRP measurements.

According to another aspect of the present disclosure, there is provided a method in an apparatus, the method comprising: communicating between the apparatus and a network device information related to one or more beam reliabilities, wherein each beam reliability relates to beam time-of-stay or beam blockage probability and beam time-of-stay for a respective beam for the apparatus.

In some embodiments, the information related to one or more beam reliabilities comprises a respective set of one or more bits indicating reliability of each beam.

In some embodiments, the one or more bits are used to classify each beam into one of up to 2^{N} levels of reliability, where N is the number of bits in the respective set of bits indicating reliability of each beam.

In some embodiments, each level of beam reliability is associated with a respective range of beam time-of-stay and beam blockage probability.

In some embodiments, the information related to one or more beam reliabilities is obtained from one or more of an estimate of location of the apparatus; an estimate of velocity of the apparatus; an information store containing information about which beams can be used as a function of location; an information store containing information about blockage probability as a function of location and time; sensing information obtained by either the network device or the apparatus.

In some embodiments, the method further comprises: receiving signaling from the network device requesting the apparatus to transmit feedback regarding a certain beam or beams for the purpose of building beam reliability information; transmitting the requested feedback.

In some embodiments, the method further comprises: receiving signaling from the network device configuring a number of bits to be used to convey beam reliability.

In some embodiments, said communicating comprises transmitting the information related to one or more beam reliabilities that was produced using sensing information obtained at the apparatus.

In some embodiments, the method further comprises: based on the one or more beam reliabilities, receiving signaling from the network device, the signaling configuring beam RSRP reporting.

In some embodiments, said communicating one or more beam reliabilities comprises receiving one or more beam reliabilities; performing beam failure detection and recovery taking into account the one or more reliabilities and beam RSRP measurements.

According to another aspect of the present disclosure, there is provided a network device comprising: a processor and memory, the network device configured to perform a method as described herein.

According to another aspect of the present disclosure, there is provided an apparatus comprising: a processor and a memory, the apparatus configured to perform a method as described herein.

According to another aspect of the present disclosure, there is provided a non-transitory computer-readable medium having stored thereon, computer-executable instructions, that when executed by a computer, cause the computer to perform one of the methods as described herein.

A new method of classifying beams according to their reliability is provided; various procedures for quantifying beam reliability are provided. Methods of base station-UE communication to classify such beams are provided. New beam management procedures that are based on the new beam classification are provided.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5 depicts two scenarios for the purpose of defining beam time of stay;

FIG. 6 is a signal flow diagram for obtaining beam reliability information;

FIG. 7 is a signal flow diagram for requesting specific beam feedback;

FIG. 8 is a signal flow diagram for beam switching based on UE sensing feedback;

FIG. 9 is a signal flow diagram for performing beam sweeping and feedback for beam failure detection (BFD) and beam failure recovery (BFR); and

FIG. 10 is a signal flow diagram configuring BFD and BFR procedures that take into account beam reliability.

### DETAILED DESCRIPTION OF THE EMBODIMENTS

The current beam management procedures rely solely on beam RSRP to take decisions. This results in using beams regardless of their suitability to UE location, speed, orientation, etc. Accordingly, the beam may be switched more often than necessary leading to delays and less throughput. This approach may also lead to longer delays in beam failure detection and recovery that could have been avoided.

A new method of classifying beams according to their reliability is provided. A new beam reliability measure is provided that can provide better insights regarding which beam to use for a specific UE. Various procedures for quantifying beam reliability are provided. Methods of base station-UE communication to classify such beams are provided. New beam management procedures that are based on the new beam classification are provided.

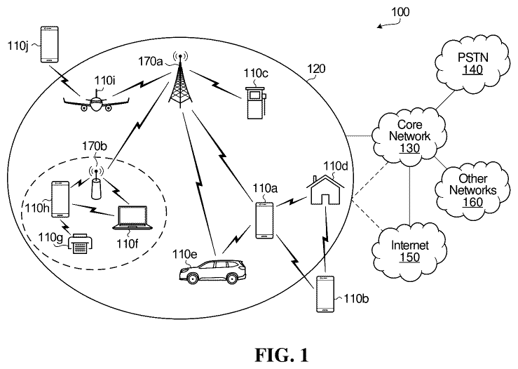

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

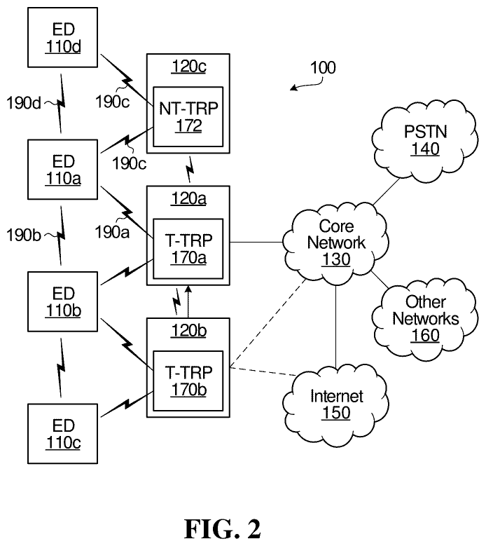

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

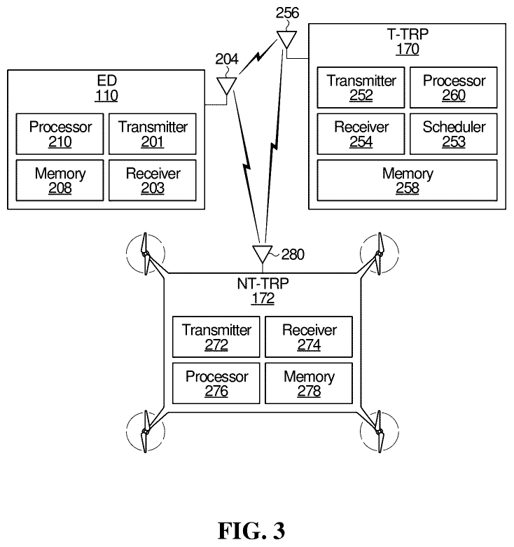

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

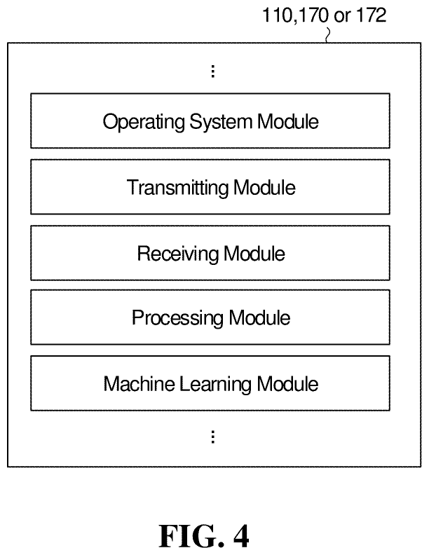

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A new measure of beam reliability measure that is based on beam time-of-stay and/or beam blockage probability is defined. A reliable beam for a certain UE can be defined as a beam that would have a longer time-of-stay (e.g. longer average time-of-stay) and/or reduced blockage probability relative to a non-reliable beam. Blockage probability is described in further detail below. The beam time-of-stay relates to how long, in terms of time, the UE can use the beam before having to switch to another one. Accordingly, a beam with a longer time-of-stay, and therefore increased reliability, would require on, average, less beam switching, and may reduce beam failure instances, and when the beam fails, may result in a decrease in the delay for beam recovery.

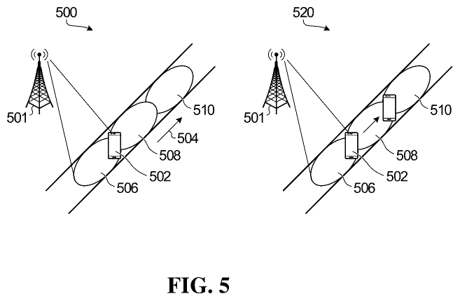

FIG. 5 depicts an example for the purpose of visualizing. A first scenario is indicated at 500. A transmit point (TP) 501 is covering a road that a UE 502 is moving on with direction of movement 504 using three beams, all three of which are line of sight (LOS). The coverage areas of the three beams are indicated at 506,508,510. If investigating which beam is better from RSRP perspective, the beams having coverage areas 506,508 may give quite similar RSRP levels. However, it is apparent from the scenario depicted that the UE is going into the coverage area 508, and going away from coverage area 506. This shows why it is the case that for two beams that may have the same RSRP level, the beam having coverage area 508 is better than the beam having coverage area 506, in the sense that the beam having coverage area 508 will be available for use by the UE for a much longer time, while the beam having coverage area 506 might fail instantly. In this sense, the beam having coverage area 508 has a longer time-of-stay than the beam having coverage area 506. Where beam reliability is associated with average time-of-stay, such that increased average time-of-stay implies improved reliability, for UE 502 at the instant depicted, the beam with coverage area 508 is more reliable than the beam with coverage area 506. It is also noted that, if there is another UE in the same location as UE 502, but going in the opposite direction, the beam reliability would be reversed; the beam with coverage area 506 would be more reliable than the beam with coverage area 508. Accordingly, it can be seen how the provided beam reliability metric is different from beam RSRP, and how it can provide better insights on which beam to use. It can also be seen that the beam reliability is UE specific. After a certain amount of time (see for example scenario 520 in FIG. 5), a beam that was reliable may not be reliable any more. In this sense, the beam reliability is UE-specific, and depends on UE location, and velocity. It may also depend on UE orientation.

Beam reliability is associated with average time-of-stay and/or blockage probability. There are measurable quantities that can be related to the proposed metric. In some embodiments, beam time-of-stay is measured historically for many UEs (by measuring when did a UE start using a beam, and when did it switch to another, or from the RSRP measurements feedback indicating that the beam has RSRP that allows proper communication with one or more UEs). Based on the historical information, the base station can relate that time-of-stay according to different beams and UE locations and velocity.

The beam time-of-stay is dependent on the velocity (speed and direction) of the UE, and for a given direction, the time-of-stay is inversely proportional to speed. The faster the UE is moving in the given direction, the faster the UE will go out of coverage, and therefore, the shorter the time-of-stay. To account for this, in some embodiments, the historical time-of-stay may be maintained according to direction, and for a predefined speed. This can be achieved by scaling each measured time-of-stay based on the actual speed of the UE that the measurement pertains to, and the predefined speed used for maintaining the time-of-stay information. Then, to determine the time-of-stay for a specific UE having a direction and speed using the stored historical information, this can be based on the stored information for that direction and the predefined speed, which is scaled according to the actual speed of the specific UE.

In some embodiments, for the purpose of enabling the determination of beam time-of-stay, the base station collects information regarding which beams are or can be used based on UE location. Based on this historical information, it can be determined that for a given UE location there will be a group of beams that can be used. This information can be stored in a database or other information store by location or by region. Then, using an actual UE location and velocity, information in the database can be used to determine the time-of-stay for each beam that can be used by that UE. The time-of-stay can, for example, be determine as follows:
Set current time-of-stay=o
Determine initial set of beams that can be used for initial location;
Increment current time-of-stay by delta t;
determine new location of UE moving at velocity v;
look up current set of beams that can be used according to the database for the new location;
for each beam that was in the initial set of beams but is not in the current set of beams, set time-of-stay for that beam=current time-of-stay-delta t;
repeat process starting from incrementing current time-of-stay until no beam from the initial set remains.

The beam reliability approach in this example involves checking the velocity for each UE and determining the average time-of-stay for each beam. This can be used for reaching a beam decision as discussed below.

As noted above, the beam reliability may also be based on blockage probability. A UE might be served by a beam that covers a large area around the UE and therefore might be expected to have a good time-of-stay, but a moving object, such as a truck, may block the beam. The blockage probability may vary by location, and time of day, for example due to the fact that traffic density varies throughout the day. In such a scenario, the logic of choosing a particular beam based on average time-of-stay may be completely sound, but in a case where there is a higher blockage probability, the resulting instantaneous beam time-of-stay drops. When such blockages happen, the UE may initiate beam failure recovery and try to find a new beam, thereby reducing the time-of-stay of the original beam. The blockage probability is a measurable quantity. In some embodiments, for the purpose of aiding in determining beam reliability, the BS obtains and keeps track of blockage probability statistics according to location and time of day. Accordingly, a beam reliability can change for the same UE having the same information (location, speed, direction) for different times of day. Accordingly, as noted previously, beam reliability can be associated with: (1) time-of-stay only, (2) probability of blockage only, and (3) both time-of-stay and probability of blockage.

Having associating beam reliability as a concept with measurable quantities; beam time-of-stay, and/or blockage probability, different methods of quantification are provided. One method of quantification involves classifying each beam for a specific UE as either reliable or non-reliable. This can be captured with a one-bit representation. In a specific example, all the possible beams for that UE are sorted according to their average time-of stay, and the half (or some other fraction) with higher values are classified as reliable and the half (or remaining fraction) with lower values are classified as non-reliable. Alternatively, the beams may be divided into a larger number of groups that again are not necessarily equal in size, each group associated with a respective reliability. A multi-bit representation can be used to indicate the group of a given beam.

In some embodiments, beam classification is based on both average time-of-stay and blockage probability, where a beam is classified to multiple levels of reliability according to these two metrics. In one example for two levels of reliability, a beam may be classified as non-reliable if the beam time-of-stay is lower than a certain threshold or the probability of blockage is higher than a certain threshold. Each level of reliability may be associated with a respective range of time-of-stay and blockage probability. For a larger number of levels for reliability, each beam may be associated with a certain reliability level depending on one or more respective thresholds for beam time-of-stay and blockage probability. Also, the most reliable beam may be associated with beam time-of-stay higher than a certain threshold, and blockage probability lower than a certain threshold.

While the focus in these examples has been on average time-of-stay and beam blockage probability, other factors may be additionally be considered as well in assessing beam reliability; e.g., beam width or interference. For example, when a beam changes its beam width, the coverage area of that beam changes as well. This means that the time-of-stay of the beam changes. Accordingly, a beam with adaptive beam width can have a range of beam time-of-stay resulting in different reliabilities as well. In another example, since beam reliability is related to beam time-of-stay, that beam RSRP can be affected with the interference levels reducing the communication rate. When that happens, beams with similar time-of-stay may be further classified according to the interference levels where those with lower interference can be deemed more reliable. Accordingly, as we can see, there may be other factors, in addition to beam time-of-stay and blockage probability, that may directly or indirectly affect the beam reliability and these factors may be used as inputs when determining the reliability of the beams.

Beam RSRP is not enough for beam management and the introduction of beam reliability can solve many problems in different beam management procedures. In some embodiments, the provided beam reliability is used in a manner that complements beam RSRP rather than replacing it. Detailed examples of beam management based on one or both of beam reliability and RSRP are provided below. Once the beam reliability is defined according to a certain format, both base station and UE may benefit from such classification in various beam management procedures. For example, a base station may prefer to switch the UE from a beam to another according to beam reliability measures, even when the filtered RSRP values of the new beam may not be higher than the current beam with a specific offset, or may be even lower. Also, a UE may use such information to easily assess beam failure and obtain a faster decision. In addition, the UE may choose a certain beam for beam failure recovery according to the beam reliability input, and this may reduce the delay of the procedure.

In some embodiments, as discussed above, beam reliability information is collected in advance. The beam reliability may, for example, indicate a beam reliability by UE location, and possibly also by UE velocity. In some embodiments, possible UE locations are grouped into regions, and possible UE velocities are also divided into velocity groups. Then a respective beam reliability may be ascertained for each region and each velocity group. This may be stored, for example, in a database or other information store. As noted previously, this may involve storing for a predefined speed, and then using that to scale for a specific speed of a UE. An example of beam reliability information is shown in Table 1 below for a case where there are 2 beams, 2 regions, and 2 velocity groups. Of course, there may be more than 2 beams, and the number or regions and velocity groups is implementation specific. Based on such a table, once the location and velocity of a UE is ascertained, the location is associated with a region, and the velocity associated with a velocity group, and the reliability of the beams can be looked up.

| Beam ID | Region | Velocity Group | Reliability |
|---|---|---|---|
| 1 | Region 1 | Velocity group 1 | Reliability (beam ID, |
| | | | Region, Velocity Group) |
| 1 | Region 1 | Velocity group 2 | |
| 1 | Region 2 | Velocity group 1 | |
| 1 | Region 2 | Velocity group 2 | |
| 2 | Region 1 | Velocity group 1 | |
| 2 | Region 1 | Velocity group 2 | |
| 2 | Region 2 | Velocity group 1 | |
| 2 | Region 2 | Velocity group 2 | |

In another example, a base station may store a first data base (or other information store) that links different possible UE locations to the beams that are reported or used by UEs in these locations. This information may be built up over time based on network usage. A second database (or other information store) may contain the probability of blockage in each area, also based on usage of the system. The second data base may be further divided into a couple of cases depending one or more factors; e.g., time of day for different traffic densities. The base station may then use the one or more data bases to assess the reliability of beams for a UE, depending on the UE's location and velocity.

In some embodiments, a UE obtains beam reliability information, either on its own through sensing or as informed by the base station. The UE may maintain a data base (or other information store). The data base created and stored by the UE may contain information relevant to one or more beams that are of interest to the UE.

In some embodiments, various sources of sensing information are used for beam reliability classification. For example, a base station may be able to obtain a satellite image of the serving area, and process that area to define blockages. The base station may use this information to classify beams as reliable or not when the UEs are entering such areas that can are blocked, for example by buildings. In another example, a base station with radar capabilities can detect a certain moving object, such as a truck, and decide which beam(s) might be blocked by that object. The base station may use this information to classify some beams as temporarily unreliable due to this moving object. The base station may use its sensing abilities to find out whether the NLOS beams used for communications are reflected from a reliable reflector (a reflector that will always be there, such as a building), or a non-reliable reflector (a reflector that would not exist after a certain time, such as a moving car). Such information can help in assessing the beam reliability for NLOS beams.

In some embodiments, a UE is equipped with sensing or radar capabilities that can be used to predict possible blockages which may then be related to the reliability of one or more beams. If the UE is, for example, a vehicle, it may also have more sensors; e.g., LIDAR, that can provide even more information. In some embodiments, sensing information from both UE and base station side may be used to assess beam reliability and this information can be combined to obtain a better-informed decision.

In some embodiments, the base station assesses the beams reliabilities and informs the UE about which beam is more reliable. Example signaling methods are provided below.

In some embodiments, a BS obtains sensing information either directly from its sensing capabilities or based on information from a UE, that relates to the reliability to one or more beams, and exploits such information to enhance one or more procedures for beam management. In one example, a UE may report that the serving beam is not reliable (for example due to fluctuating RSRP that initiates beam failure detection regularly) and according to this information, the base station assumes that this beam is not reliable and switches the UE to another beam. In this case, the information that the beam is not reliable may be the only information at the base station side; however, it was useful to avoid repeated beam failure detection at the UE side.

In some embodiments, beam reliability can be used to build a data base and assess each beam for each UE; examples are given above. However, in addition or alternatively, beam reliability can be used in an on-the-fly mode, where occasionally obtained information may be momentarily used to provide quick decision(s) at the base station or UE side according to the obtained reliability information.

Once a beam reliability data base is built, the overhead to maintain such data base is extremely low. Since the beams reflect according to the objects in an area, e.g., cars, buildings, etc, the important reflectors that are more reliable in the sense that they do not change over a long time compared to the communication system time frame. For example, buildings are more important than cars, since building change very slowly over time compared to communication systems. While cars may change a lot, they are not that important to keep track of, since they are not reliable reflectors in the first place. A beam reliability data base may be triggered to update when beam reporting is inconsistent with the data base. In one example of such an inconsistency, a UE may report a certain beam as a good beam (in terms of high RSRP) in a location that was never associated to this beam; in another example, a UE may report a beam as a bad beam (in terms of low RSRP), when such beam was used frequently by many other UEs in the same location. This may have been due to a new building being built or a previously existing building being demolished. The time scale of such events is much longer than that of communication systems providing an extremely low overhead.

### Base Station-UE Communication Regarding Beam Reliability

In this embodiment, the base station communicates with the UE so that the UE can provide the base station with information about one or more beams regarding their reliability. The UE may send the conventional RSRP measurements for the operating beam, for example as described in current standards. The UE may also send the RSRP for a certain beam as instructed by the base station. The base station may provide the UE with the time and frequency resources and configuration information that enables the UE to provide such feedback. The UE may also provide sensing information such as its location, velocity, orientation, etc. The UE may be instructed to provide the beam direction for its receive beam for the operating beam or another beam as specified by the base station. The UE may inform the base station regarding the best receive beam for a specific transmit beam as configured by the base station. The UE may be able to use its sensing information to know whether the serving beam is LOS or NLOS beam and can then inform the base station such information.

Since beam reliability can be quantified in different ways, the base station and the UE may use a common defined way to express the beam reliability; e.g., using a defined number of bits, or they can communicate to indicate the precision used. In one scenario, the base station and UE express reliability in one bit having two states associated with either reliable or non-reliable. In another scenario, the reliability is expressed as a multi-level value that is presented with more than one bit. Since beam reliability relates to the beam time-of-stay, the beam reliability may be associated implicitly or explicitly with a time stamp that relates to how long that beam may be useful. A beam may be stamped for future use indicating that it will be useful after a given time, or at a certain location the UE is heading to.

The UE may send reliability information regarding one or more beams according to a predefined or agreed format. The UE may have information that indicates that a given beam will be unreliable, and send such data to the base station. For example, the UE may predict a beam failure due to possible beam blockage. The base station may use such information to decide to switch the beam to another one.

The base station may send the reliability information regarding one or more beams for the UE to exploit in one or more beam management procedures. The information may be regarding the serving beam, and can be for multiple serving beams for the case of multi-beam communication. The information may also be for other beams that the UE is not currently using, but can be helpful in one or more of beam management procedures.

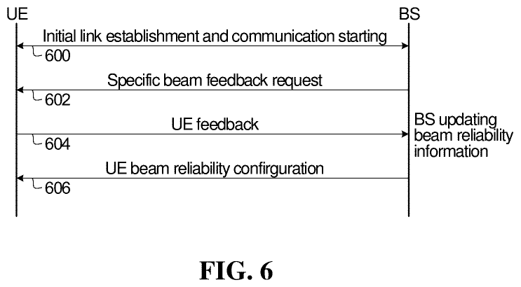

In some embodiments, signaling is used that enables the base station to build a data base of beam reliability. Signaling can also be used to configure how beam reliability is to be expressed. Signaling can also be used to inform the UE with the beams reliabilities that can benefit that UE. A specific signaling example is shown in FIG. 6 in which after a UE and a base station establish a link for communication at 600, at 602 the base station instructs the UE to send feedback regarding a certain beam or beams for use in building the beam reliability data base, and at 604 the UE sends the requested feedback. This can be for example the RSRP for a certain beam. Later, at 606, the base station sends a configuration to the UE regarding the beam reliability. This can include for example, the number of bits to express reliability. The communication following such signaling can be downlink or uplink.

When the UE provides the BS with information related to beam reliability, the base station can use such information, in addition to its own information to classify the possible beams for each UE. Accordingly, the beams used at the BS will be better suited to the sensing information of the UE. That can enhance the performance in terms of one or more metrics, e.g., throughput, reliability, lower overhead, etc.

### Beam Switching Exploiting Reliability

In some embodiments, the new beam reliability metric is used in one or more beam management applications, for example beam switching applications. This can be used based on a complete data base for beam reliability such as described above, or based on information that relates to the reliability of one or more beams that is obtained on the fly.

In current procedures, the base station decides whether to instruct the UE to switch beams or not based on the RSRP measurement feedback from the UE that includes the measurement for one or more beams. In some embodiments, the base station may exploit the reliability information by adapting the amount of RSRP feedback overhead according to the beam reliability. For example, a UE that is served with a reliable beam can be instructed to provide less frequent RSRP measurements; this has the effect of decreasing the RSRP feedback overhead. In another implementation, a UE that is served by a reliable beam is instructed to provide RSRP feedback information regarding a number of beams that is less than the corresponding number of beams for which RSRP feedback is provided by another UE that is served by a non-reliable beam. Since reliability can be based on UE sensing such as UE location, velocity, and orientation, such sensing information may be implicitly or explicitly used in beam switching based on beam reliability.

In another specific example, the base station uses the RSRP values to determine whether a beam switch is required or not. Beam reliability can be used to enhance this process by adapting the decision to the beam reliability. In one implementation, a reliable beam serving a UE would remain as the serving beam unless a beam with larger RSRP offset is found compared to when the serving beam is unreliable. In another implementation, a non-reliable beam would be switched faster than a reliable beam by using shorter filters to decrease the switching delay. Beam reliability can be combined with periodic RSRP feedback from the UE to allow a better informed decision about whether to switch the beams or not, which can help reduce the switching delay when needed, and avoid switching when not needed, reducing the ping-pong effect. A ping-pong effect happens when a UE that is served by a beam is switched to a second beam, then back to the first beam. This effect wastes throughput and time and can be avoided by better classification of beams.

In addition to the possible updates to the beam switching algorithms such as discussed above, the base station can further instruct the UE to update its receive beam and/or its receive panel based on the transmitter beam reliability and UE measurement feedback. When the receive beam is not correctly set, or was set but requires updating, for example due to UE rotation, or when the panel receiving the beam may be partially covered, for example due to hand grip, the transmitter beam may be still operational and able to provide good RSRP. In such a case, the base station, based on beam reliability and RSRP measurement feedback from the UE, can instruct the UE to switch to another panel or update its receive beam or both. The receive beam update can be indicated by a certain beam, or the UE may be configured to do a receive beam sweep to obtain the best receive beam.

A base station that is serving a UE using a certain beam, can receive information from the UE regarding the reliability of that beam. In one example, the UE may detect an object that is going to the direction of the beam causing possible beam blockage. The UE may send information to the base station indicating that the beam is non-reliable. The base station may initiate beam switching based on UE feedback. In another example, the UE detects that it is going around a building that would cut the path of its serving beam, and accordingly, the UE sends a non-reliability indication to the base station to request beam switching. In a third example, a UE finds that the serving beam frequently drops, but not frequent enough to trigger a beam switching, and sends a non-reliability feedback to the base station triggering beam switching. In a fourth example, the UE may predict beam failure using for example, artificial intelligence (AI), or through sensing indicating handgrip and sends non-reliability indication to the base station to request beam switching.

A base station may ask the UE to switch to another beam even if the new beam may not be the beam providing the highest RSRP due to that beam being more reliable according to the base station information. The base station may connect to the UE using one or more beams, each with the same or different reliabilities, for the same or different purposes; e.g., data or control beams. The base station may use the same beam for one or more UEs where the UEs can be multiplexed using different time, frequency or power domain. The one or more beams can be of similar or different frequency ranges.

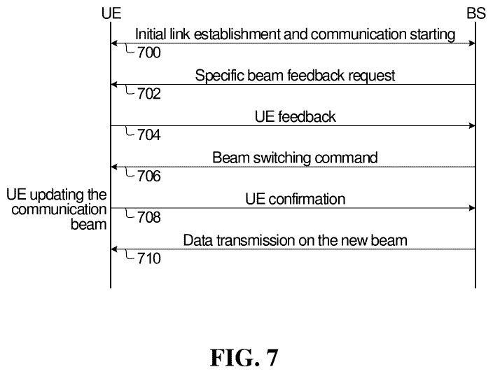

In a specific signaling example shown in FIG. 7, after a conventional link establishment and starting communication at 700, the base station requests a certain feedback from the UE to determine the reliability of a certain beam at 702. At 704, the UE sends the required feedback. After some time, the base station decides to switch beams as another beam is deemed more reliable for that UE. Beam switching is executed through a beam switching command 706 and UE confirmation 708. After that, data transmission takes place using the new beam at 710.

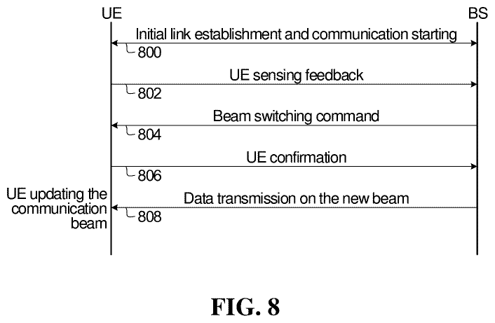

In another specific signaling example shown in FIG. 8, after a conventional link establishment and starting communication at 800, the UE sends sensing information at 802 indicating that the current beam is no longer reliable, and the base station initiates a beam switching 804,806 and after that, data transmission takes place using the new beam at 808.

When the base station and UE exploit the available information regarding the beam reliability, the beam switching procedure and RSRP reporting feedback can have multiple gains. The UE can reduce the feedback overhead, the base station can make better informed decision to avoid the ping-pong effect, and beam failure probability can be decreased by switching to better beams.

### Beam Failure Detection and Recovery Exploiting Beam Reliability

In some embodiments, enhanced beam failure detection and recovery procedures are provided that can exploit the new beam reliability metric, whether by using a data base at the base station or through various sensing information obtained on-the-fly by the base station or UE.

In current procedures, the UE decides whether a beam failed or not according to measurements of the beam RSRP using certain configured time constraints relating to a number of measurements over a time period. In this embodiment, a UE may have different configurations in terms of how to declare beam failure; each configuration may correspond to a different beam reliability. The purpose of such configurations would be to enable the UE to determine a beam has failed or not faster without any unnecessary delays. By using the beam reliability, the procedure can be tailored by precisely selecting configuration parameters according to the reliability level of the beam thereby providing faster and more accurate procedure. A UE that has received a beam reliability information from the base station, or has obtained such reliability information using its own sensing and measurements, can use the corresponding configuration of how to declare beam failure.

In one example, the UE receives from the base station information indicating that the current serving beam is not reliable, and accordingly, the UE might use a configuration that results in the UE declaring beam failure with fewer measurements and/or during a shorter time period when compared to the procedure when the serving beam is reliable. In another example, the UE obtains sensing information that indicates that the serving beam is not reliable, and the UE uses a configuration that results in faster detection of beam failure.

In some embodiments, the UE further exploits the beam reliability to know when there is beam failure, whether the problem is on the transmitter beam, or the problem is in the receive beam and/or panel. In the latter case, the UE might switch the panel and/or update the receive beam in an attempt to restore the connection first before declaring beam failure. The base station may provide the UE with a list that relates each possible transmit beam with possible pairs of receive beams and panels, when the UE is equipped with multiple panels. In another implementation, the UE may be able to understand how to receive the same transmit beam by different panels and receive beams by being programmed with the spatial relative positions of the panels and their orientations, with optional further use of measurements of reference signals from the base station.

In some embodiments, the UE makes use of RSRP values of the serving beam, in addition to the reliability information that can obtained from UE sensing or form the BS, to further enhance the beam failure detection. For example, in a situation where a beam that is deemed non-reliable is accompanied by quickly deteriorating RSRP values, this might be an indication of blockages, and the UE may use this to declare beam failure faster.

Since a beam failure procedure in conventional systems is initiated only when the RSRP value is below a given threshold, the base station typically configures the UE in advance to be prepared for such scenarios. When using beam reliability, the base station may include more than one configuration scenario that corresponds to UE behaviour for different beam reliability inputs. The UE may also be programmed assuming some default configurations.

Once a beam is declared to fail, the UE may start beam failure recovery. The UE can use the beam reliability inputs in addition to the conventional configuration from the base station to figure out which beams are more likely to operate. The list of resources used for beam failure recovery may contain different transmit beams and the associated receive beam and panel for proper communication. The beam reliability may be provided for one or more beams from the base station side, or may be obtained from the UE sensing information.

According to the beam reliability input, the UE may use different configurations to check whether the beam is good for beam failure recovery. In one scenario, the UE would use less measurements or shorter time slots to check a reliable beam from the list when compared to checking a non-reliable beam. The UE may start checking a beam that may not provide the highest RSRP, but of higher reliability for possible beam failure recovery.

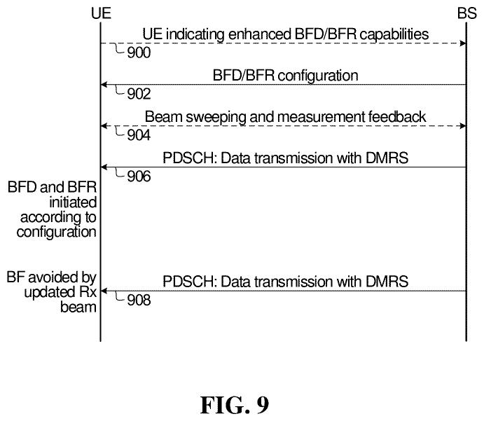

A signaling example is shown in FIG. 9 in which at 900 a UE indicates its ability to exploit beam reliability in beam failure detection and recovery to the base station. At 902, the base station transmits signaling configuring the UE with a configuration that enables a faster and improved performance using beam reliability. At 904, a beam sweeping may be done to help the UE associate the transmit beam with different receive beams and panels. Data transmission takes place at 906. During the communication, the beam is assumed to temporarily fail, and the UE was able to restore the communication by updating the receive beam, and data transmission continues using the same beam at 908.

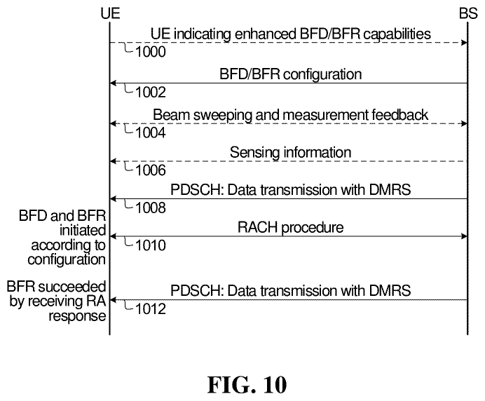

Another signaling example is shown in FIG. 10 in which at 1000 a UE indicates its ability to exploit beam reliability in beam failure detection and recovery to the base station. At 1002, the base station configures the UE with a configuration that enables a faster and improved performance using beam reliability. At 1004, a beam sweeping may be done to help the UE associate the transmit beam with different receive beams and panels. At 1006, the base station further sends sensing information that relates to the reliability information of one or more beams to be used for possible beam recovery. Data transmission takes place at 1008. During the communication, the beam fails, and the UE may use such information to enhance the beam failure detection and recovery. A RACH procedure takes place at 1010, and communication using the new beam takes place at 1012.

When the base station and UE exploit the available sensing information regarding the beam reliability in addition to UE RSRP measurements, the beam failure detection and recovery procedures at the UE side can have multiple gains. The UE can restore the communication by updating the receive beam and/or panel when possible, can reduce the time to announce beam failure, and can reduce the time for possible beam recovery.

Numerous modifications and variations of the present disclosure are possible in light of the above teachings. It is therefore to be understood that within the scope of the appended claims, the disclosure may be practiced otherwise than as specifically described herein.

While the focus of the detailed embodiments has been for beam reliability and associated beam management, beam failure and beam recovery procedures for downlink transmission from a network device to an apparatus such as a UE, more generally, the metric of beam reliability can be for any kind of link whether uplink, downlink, sidelink or backhaul. The system can, for example, be frequency division duplex (FDD) or time division duplex (TDD).

The described embodiments can be applied to cases where the BS and/or UE is a satellite, drone, vehicle, IoT, etc., as long as these devices are capable of beam-based communication. In general, the embodiments apply to devices that are capable of beamforming.

What is claimed:

1. A method, the method comprising:
communicating, between a network device and an apparatus, information related to one or more beam reliabilities, wherein each beam reliability relates to (1) beam time-of-stay or (2) beam blockage probability and the beam time-of-stay, for a respective beam for the apparatus.

2. The method of claim 1, wherein the information related to the one or more beam reliabilities comprises a respective set of one or more bits indicating a respective beam reliability of each beam.

3. The method of claim 2, wherein the one or more bits are used to classify each beam into one of up to 2^{N} levels of reliabilities, where N is a number of bits in the respective set of one or more bits indicating the respective beam reliability of each beam.

4. The method of claim 3, wherein each level of beam reliabilities is associated with a first respective range of the beam time-of-stay and a second respective range of the beam blockage probability.

5. The method of claim 1, wherein the information related to the one or more beam reliabilities is obtained from one or more of:
an estimate of location of the apparatus;
an estimate of velocity of the apparatus;
an information store containing information about which beams can be used as a function of location;
an information store containing information about blockage probability as a function of location and time; or
sensing information obtained by either the network device or the apparatus.

6. The method claim 1, further comprising:
transmitting signaling to the apparatus requesting the apparatus to transmit feedback regarding a certain beam or beams for purpose of building beam reliability information; and
receiving the feedback.

7. The method of claim 1, further comprising:
transmitting signaling to the apparatus configuring a number of bits to be used to convey a respective beam reliability of each beam.

8. A method, the method comprising:
communicating, between an apparatus and a network device, information related to one or more beam reliabilities, wherein each beam reliability relates to (1) beam time-of-stay or (2) beam blockage probability and the beam time-of-stay, for a respective beam for the apparatus.

9. The method of claim 8, wherein the information related to the one or more beam reliabilities comprises a respective set of one or more bits indicating a respective beam reliability of each beam.

10. The method of claim 9, wherein the one or more bits are used to classify each beam into one of up to 2^{N} levels of reliabilities, where N is a number of bits in the respective set of one or more bits indicating the respective beam reliability of each beam.

11. A network device, comprising:
one or more processors, when executing program instructions stored in the network device, cause the network device to:
communicate, between the network device and an apparatus, information related to one or more beam reliabilities, wherein each beam reliability relates to (1) beam time-of-stay or (2) beam blockage probability and the beam time-of-stay, for a respective beam for the apparatus.

12. The network device of claim 11, wherein the information related to the one or more beam reliabilities comprises a respective set of one or more bits indicating a respective beam reliability of each beam.

13. The network device of claim 12, wherein the one or more bits are used to classify each beam into one of up to 2^{N} levels of reliabilities, where N is a number of bits in the respective set of one or more bits indicating the respective beam reliability of each beam.

14. The network device of claim 13, wherein each level of beam reliabilities is associated with a first respective range of the beam time-of-stay and a second respective range of the beam blockage probability.

15. The network device of claim 11, wherein the information related to the one or more beam reliabilities is obtained from one or more of:
an estimate of location of the apparatus;
an estimate of velocity of the apparatus;
an information store containing information about which beams can be used as a function of location;
an information store containing information about blockage probability as a function of location and time; or
sensing information obtained by either the network device or the apparatus.

16. The network device of claim 11, wherein the one or more processors further cause the network device to:
transmit signaling to the apparatus requesting the apparatus to transmit feedback regarding a certain beam or beams for purpose of building beam reliability information; and
receive the feedback.

17. The network device of claim 11, wherein the one or more processors further cause the network device to:
transmit signaling to the apparatus configuring a number of bits to be used to convey a respective beam reliability of each beam.

18. An apparatus, comprising:
one or more processors, when executing program instructions stored in the apparatus, cause the apparatus to:
communicate, between the apparatus and a network device, information related to one or more beam reliabilities, wherein each beam reliability relates to (1) beam time-of-stay or (2) beam blockage probability and the beam time-of-stay, for a respective beam for the apparatus.

19. The apparatus of claim 18, wherein the information related to the one or more beam reliabilities comprises a respective set of one or more bits indicating a respective beam reliability of each beam.

20. The apparatus of claim 19 wherein the one or more bits are used to classify each beam into one of up to 2^{N} levels of reliabilities, where N is a number of bits in the respective set of one or more bits indicating the respective beam reliability of each beam.
